(19) United States
(12) Patent Application Publication
(10) Pub. No.: US 2018/0245939 A1
(43) Pub. Date: Aug. 30, 2018

(54) Method, System and Vehicle Comprising Said System for Transmitting a Navigation Destination to a Navigation Device of the Vehicle

(71) Applicant: Bayerische Motoren Werke Aktiengesellschaft, Muenchen (DE)

(72) Inventors: Anastasia PETROU, Munich (DE); Dominik GUSENBAUER, Seattle, WA (US)

(21) Appl. No.: 15/968,469

(22) Filed: May 1, 2018

Related U.S. Application Data
(63) Continuation of application No. PCT/EP2016/072418, filed on Sep. 21, 2016.

(30) Foreign Application Priority Data
Nov. 2, 2015 (DE) 10 2015 221 419.2

(51) Int. Cl. G01C 21/36

(52) U.S. Cl. CPC G01C 21/362

(57) ABSTRACT

A method for transmitting a navigation destination to a navigation appliance of a vehicle includes: receiving navigation destination data from a first, mobile communication device via a second, mobile communication device; producing a list of geocoding services for geocoding the navigation destination data; determining a geocoding service from the list of geocoding services; geocoding the navigation destination data using the defined geocoding service; transmitting the geocoded navigation destination data to the navigation appliance of the vehicle; identifying a collision between the geocoded navigation destination data and possible navigation destination data of a navigation map of the navigation appliance of the vehicle; and adopting the geocoded navigation destination data as the navigation destination of the navigation appliance of the vehicle if a collision is not identified.

### CROSS REFERENCE TO RELATED APPLICATIONS

This application is a continuation of PCT International Application No. PCT/EP2016/072418, filed Sep. 21, 2016, which claims priority under 35 U.S.C. § 119 from German Patent Application No. 10 2015 221 419.2, filed Nov. 2, 2015, the entire disclosures of which are herein expressly incorporated by reference.

### BACKGROUND AND SUMMARY OF THE INVENTION

The invention relates to a method for transmitting a navigation destination to a navigation device of a vehicle. The invention also relates to a system and a vehicle equipped with the system for transmitting a navigation destination to a navigation device of the vehicle.

Navigation systems installed in vehicles can be operated using operating and/or display elements of the vehicle. DE 10 2010 038 425 A1 discloses, for example, a motor vehicle navigation system having a navigation device which is permanently installed or can be installed in a motor vehicle. The motor vehicle navigation system includes a mobile navigation memory which is set up to capture and store spoken (voice) navigation destinations and to transmit them to the navigation device using an interface between the navigation device and the navigation destination memory.

An object of the invention is to improve transmission of a navigation destination to a vehicle. In particular, an object of the invention is to transmit a navigation destination to a navigation device of a vehicle in a simpler and more flexible manner.

This and other objects are achieved by a method for transmitting a navigation destination to a navigation device of a vehicle, the method comprising the acts of: receiving navigation destination data from a first mobile communication apparatus by way of a second mobile communication apparatus; generating a list of geocoding services for geocoding the navigation destination data; determining a geocoding service from the list of geocoding services; geocoding the navigation destination data using the determined geocoding service; transmitting the geocoded navigation destination data to the navigation device of the vehicle; identifying a collision between the geocoded navigation destination data and possible navigation destination data from a navigation map of the navigation device of the vehicle; and adopting the geocoded navigation destination data as the navigation destination of the navigation device of the vehicle if a collision has not been identified.

According to a first aspect of the invention, a method is provided for transmitting a navigation destination to a navigation device of a vehicle. The method comprises receiving navigation destination data from a first mobile communication apparatus by way of a second mobile communication apparatus, and generating a list of geocoding services for geocoding the navigation destination data. The list of geocoding services can preferably be generated on the basis of the received navigation destination data. If the received navigation destination data comprise, for example, a location description or address data, a list of geocoding services can be compiled in a manner corresponding to the type of data to be geocoded. For geocoding address data, geocoding services for geocoding address data can be determined and compiled in a list, for example. The list of geocoding services may comprise, for example, all geocoding services installed on a mobile communication apparatus. The list of geocoding services may comprise, for example, only geocoding services for which data which make it possible to geocode the received navigation destination data are available. The method also comprises determining a geocoding service from the list of geocoding services. A geocoding service can be selected on the basis of a user preference. Additionally or alternatively, a geocoding service can be selected on the basis of an accuracy of the geocoding service. The accuracy of the geocoding service can be defined as the accuracy with which a user can be guided to a navigation destination. The method also comprises geocoding the navigation destination data using the determined geocoding service, transmitting the geocoded navigation destination data to the navigation device of the vehicle, identifying a collision between the geocoded navigation destination data and possible navigation destination data from a navigation map of the navigation device of the vehicle, and adopting the geocoded navigation destination data as the navigation destination of the navigation device of the vehicle if a collision has not been identified.

Geocoded navigation destination data can be advantageously transmitted with a high degree of accuracy or precision to a permanently installed or permanently installable navigation device of a vehicle. The navigation device of the vehicle can therefore always be supplied with up-to-date geocoded navigation destinations even if the navigation device of the vehicle has no opportunity to update the navigation map data online. Furthermore, mobile communication devices can be efficiently used as input devices of navigation destination data for the navigation device of the vehicle in order to capture navigation destination data in a simpler and more efficient manner and to make them available to the navigation device for route planning.

According to one advantageous configuration, the navigation destination data from the first mobile communication apparatus comprise geocoded navigation destination data. This makes it possible to efficiently geocode navigation destination data on an input device for navigation destination data. The geocoded navigation destination data can be checked and/or corrected during further processing in order to efficiently improve the accuracy of the geocoded navigation destination data. The navigation device of the vehicle can therefore receive geocoded navigation destination data of high quality and with a high degree of accuracy.

According to another advantageous configuration, the method can also comprise comparing the received geocoded navigation destination data from the first mobile communication apparatus with the geocoded navigation destination data from the determined geocoding service with regard to accuracy of the geocoded navigation destination data, and selecting the more accurate geocoded navigation destination data as the geocoded navigation destination data which are transmitted to the navigation device of the vehicle. This makes it possible to efficiently improve the accuracy of the geocoded navigation destination data for the navigation device of the vehicle.

According to another advantageous configuration, the second mobile communication apparatus may be a mobile telephone/smartphone, and/or the first mobile communication apparatus may be augmented reality glasses or a smartwatch. This makes it possible to efficiently couple different input devices to a navigation device of the vehicle via a smartphone in order to transmit navigation destinations to the navigation device of the vehicle. The navigation device of the vehicle must only have a connection to the smartphone in order to be able to communicate with the augmented reality glasses and/or the smartwatch. The navigation device of the vehicle can therefore be efficiently expanded with further input devices which would otherwise not be present in the life cycle of the navigation device. The flexibility of the input of navigation destinations can therefore be efficiently improved.

According to another advantageous configuration, the method can also comprise receiving an input from a user by way of the first mobile communication apparatus, wherein the input from the user describes the navigation destination, and setting up a communication connection between the first mobile communication apparatus and the second mobile communication apparatus. This makes it possible to combine a plurality of mobile communication apparatuses in order to input or be able to capture a navigation destination in a simpler and more flexible manner. The navigation destination may comprise a description, a name, an address, image and/or video information of the navigation destination. A navigation destination should be able to be specified as clearly as possible from said information or data. Additionally or alternatively, the input from the user may describe a multiplicity of navigation destinations, for example a restaurant in a particular environment, from which a selection can be made on the navigation device of the vehicle.

According to another advantageous configuration, the identification of a collision can check whether the geocoded navigation destination data can be mapped to possible navigation destination data from the navigation map of the navigation device of the vehicle. This makes it possible to efficiently prevent errors when adopting geocoded navigation destination data into the navigation device of the vehicle.

According to another advantageous configuration, the method may comprise, if a collision has been identified, determining geocoded navigation destination data which are closest to the transmitted geocoded navigation destination data in the navigation map of the vehicle, and adopting the determined geocoded navigation destination data as the navigation destination of the navigation device of the vehicle. The geocoded navigation destination data transmitted to the navigation device can thereby be adapted to the navigation device and, in particular, to the navigation map of the navigation device.

According to another aspect, the invention is distinguished by a system for transmitting a navigation destination to a navigation device of a vehicle, wherein the system is designed to carry out the method.

According to another aspect, the invention is distinguished by a vehicle comprising a system for transmitting a navigation destination to a navigation device of the vehicle, wherein the system is designed to carry out the method.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 schematically shows an exemplary system for transmitting a navigation destination to a navigation device of a vehicle.

FIG. 2 schematically shows an exemplary flowchart of a method for transmitting a navigation destination to a navigation device of a vehicle.

### DETAILED DESCRIPTION OF THE DRAWINGS

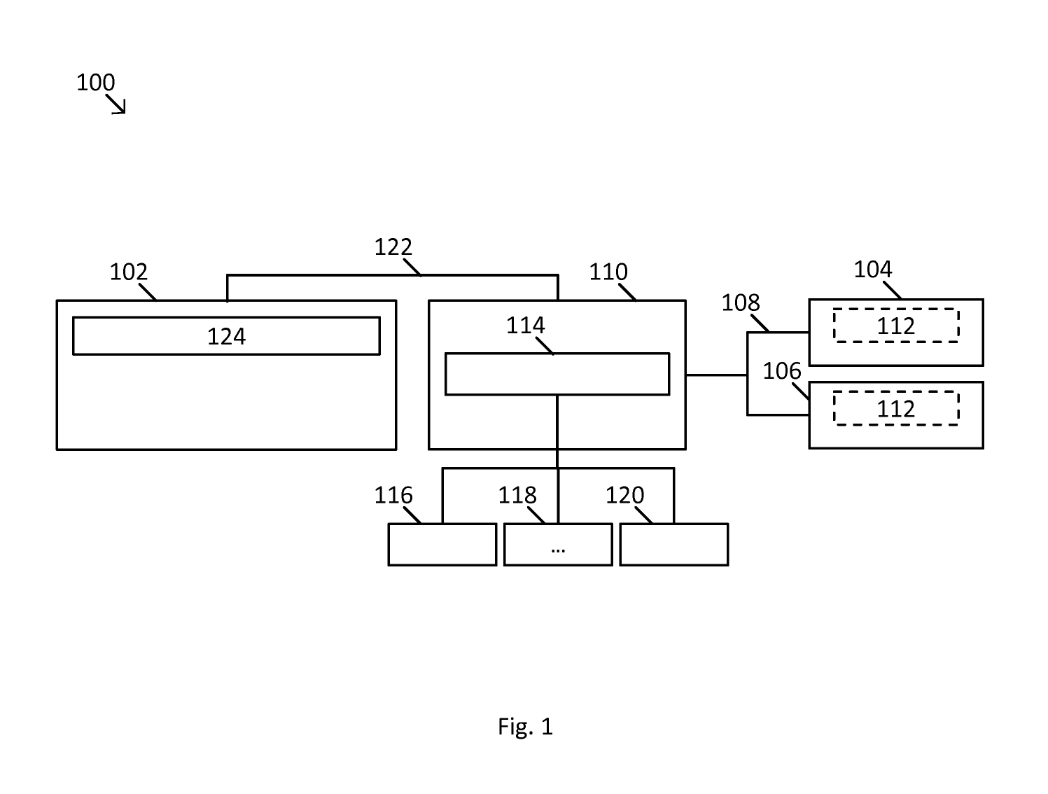

In detail, FIG. 1 shows a system 100 for transmitting a navigation destination to a navigation device 102 of a vehicle. The navigation destination can be input by a user using one of the mobile communication apparatuses 104, 106. The mobile communication apparatus 104 may be, for example, augmented reality glasses, and the mobile communication apparatus 106 may be a smartwatch, for example. A navigation destination can be input as a voice input, a gesture input and/or a touch input using one of the mobile communication apparatuses 104, 106. The navigation destination may also be input using operating elements such as rotary and/or pressing actuating controllers. A navigation destination can also be input via an image analysis of image data from a camera sensor of the mobile communication apparatuses 104, 106. The mobile communication apparatuses 104, 106 may optionally comprise a geocoding module 112 which can geocode the navigation destination input by the user. Within the scope of this application, geocoding is a process in which geospatial information, for example GPS or WGS84 coordinates, is added to a data record, for example the received navigation destination data.

The mobile communication apparatuses 104, 106 may set up a communication connection to a further mobile communication apparatus 110 via a wireless interface 108. The further mobile communication apparatus 110 may be a smartphone which can communicate with the navigation device 102 of the vehicle. The wireless interface 108 may be a near-field communication interface, a Bluetooth interface, a wireless local area network (WLAN) interface and/or a mobile radio interface.

The mobile communication apparatus 110 can receive navigation destination data and/or geocoded navigation destination data from the mobile communication apparatuses 104, 106. The mobile communication apparatus 110 comprises a geocoding module 114. The geocoding module 114 can communicate with various geocoding services 116, 118, 120 in order to geocode the received navigation destination data. For this purpose, the geocoding module 114 can generate a list of geocoding services 116, 118, 120 on the basis of the navigation destination data to be geocoded. From the generated list of geocoding services, the geocoding module 114 can select that geocoding service which can geocode the navigation destination data with the highest degree of accuracy. Additionally or alternatively, the geocoding module 114 can select that geocoding service which comprises the most up-to-date position data for the navigation destination data. The navigation destination data may comprise a restaurant name, for example. The restaurant has received new address data, for example as a result of a move. The geocoding module 114 can select that geocoding service which can geocode the navigation destination data, for example the restaurant name, using the most up-to-date and therefore correct address data. The geocoding services 116, 118, 120 can be requested by the mobile communication device 110 via a wireless interface, for example a mobile radio interface.

If the navigation destination data received by the mobile communication apparatus 110 comprise geocoded navigation destination data, the geocoding module 114 of the mobile communication apparatus 110 can compare the received geocoded navigation destination data with the geocoded navigation destination data generated by a selected geocoding service 116, 118, 120. For example, the geocoding module 110 can select those geocoded navigation destination data which have a higher degree of accuracy and/or have been geocoded using more up-to-date navigation destination data.

The geocoded navigation destination data determined by the geocoding module 114 of the mobile communication apparatus 110 can be transmitted to the navigation device of the vehicle via an interface 122. The interface 122 may be a vehicle-specific interface which is either wired or wireless. The geocoded navigation destination data can be transmitted, for example, using a snap-in adapter via which the mobile communication apparatus 110 is connected to the navigation device 102.

The navigation device 102 of the vehicle can receive the geocoded navigation destination data via the interface 122. The navigation device 102 may comprise a module 124 for identifying a collision. The module 124 for identifying a collision, also called collision identification module 124 below, can check whether the geocoded navigation destination data can be mapped to possible navigation destination data from a navigation map of the navigation device 102. If no mapping can take place, that is to say there is a collision, the collision identification module 124 can determine geocoded navigation destination data which are closest to the received geocoded navigation destination data. These determined geocoded navigation destination data can be used by the navigation device 102 as the (substitute) navigation destination. If mapping can take place, that is to say there is no collision, the collision identification module 124 can transmit the received geocoded navigation destination data to the navigation device 102 as the navigation destination. In other words, the navigation device 102 can use the received geocoded navigation destination data as the navigation destination directly, that is to say without changing or adapting the received geocoded navigation data.

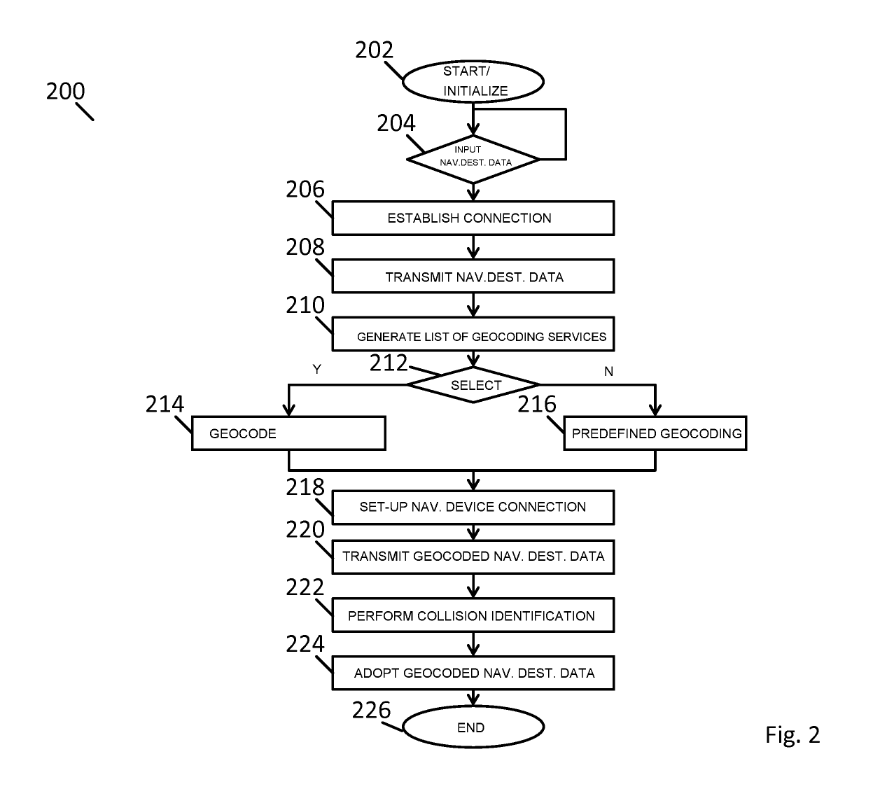

In detail, FIG. 2 shows an exemplary flowchart of a method 200 for transmitting a navigation destination to a navigation device 102 of a vehicle. The method 200 can be started in step 202. When the method 200 is started, the mobile communication apparatuses 104, 106, 110 and the navigation device 102 can be started, variables can be initialized, and/or sensors and/or input devices of the mobile communication apparatus 104, 106 can be prepared or initialized for input of navigation destination data, for example. After the method has been started 202, a user can input 204 navigation destination data. The navigation destination data can be input via an input interface of one of the two mobile communication apparatuses 104, 106. The input interface may be an input interface for voice, a touchscreen and/or a gesture recognition unit. Furthermore, the input interface may comprise a camera sensor which can identify navigation destination data by analyzing image data from the camera sensor. If input of navigation destination data has not been identified or has not been completed, the inputting 204 of navigation destination data can be repeated. If the navigation destination data are input 204 completely and/or correctly, a connection can be set up 206 between one of the mobile communication apparatuses 104, 106 and the mobile communication apparatus 110. The connection between the mobile communication apparatuses 104, 106 and the mobile communication apparatus 110 is preferably set up by means of a wireless interface 108. The navigation destination data which have been input can be transmitted 208 to the mobile communication apparatus 110 via the connection which has been set up. The transmitted navigation destination data may comprise geocoded navigation destination data.

The mobile communication apparatus 110 can generate or determine 210 a list of geocoding services 116, 118, 120, preferably on the basis of the received navigation destination data. The geocoding module 114 of the mobile communication apparatus 110 can select 212 a geocoding service 116, 118, 120 from the list of generated geocoding services 116, 118, 120. If a geocoding service has been selected 212 from the list of geocoding services, the navigation destination data can be geocoded 214 using the selected geocoding service. If a geocoding service 116, 118, 120 has not been selected, for example if an appropriate geocoding service 116, 118, 120 is not available in the list of geocoding services 116, 118, 120, a predefined geocoding service can be used 216 to geocode the navigation destination data.

After the navigation destination data have been geocoded by a selected or predefined geocoding service 116, 118, 120, the mobile communication apparatus 110 can set up 218 a connection to a navigation device 102 of a vehicle. The connection can be effected via a wired or wireless vehicle-specific interface 122. The geocoded navigation destination data can be transmitted via the connection which has been set up. The connection can be set up in an automated manner via the interface 122, for example if the mobile communication apparatus 110 is in the range of the wireless interface of the vehicle or of the navigation device of the vehicle or if the mobile communication apparatus is connected to the vehicle and to the navigation device 102 of the vehicle via a snap-in adapter.

The mobile communication apparatus 110 can transmit 220 the geocoded navigation destination data to the navigation device 102 of the vehicle via the connection which has been set up. The navigation device 102 of the vehicle can carry out 222 collision identification for the received geocoded navigation destination data from the mobile communication apparatus 110. The collision identification checks whether the received geocoded navigation destination data can be mapped to possible navigation destination data from the navigation map of the navigation device 102. If the received geocoded navigation destination data can be mapped to the navigation map of the vehicle, there is no collision and the geocoded navigation destination data can be adopted 224 into the navigation device 102 as the navigation destination. If the received geocoded navigation destination data cannot be mapped to the navigation map of the vehicle, there is a collision. In the event of a collision, the collision identification can determine geocoded navigation destination data which are closest to the received geocoded navigation destination data. The determined geocoded navigation destination data can be adopted 224 into the navigation device 102 as the navigation destination. The method 200 ends 226 after the navigation destination has been adopted.

Navigation destinations can therefore be advantageously input using augmented reality glasses or smartwatches, for example, and can be transmitted to the vehicle and to the navigation device 102 of the vehicle with the aid of a smartphone which is coupled to the vehicle. It is therefore possible to input navigation destinations in a simpler and more flexible manner. Furthermore, the navigation destination can already be transmitted to the navigation device in geocoded form, with the result that the navigation destination can be mapped to a format comprehensible to the navigation device in an accurate and up-to-date manner. Navigation destination data can therefore be input and transmitted more efficiently. Furthermore, mobile communication apparatuses belonging to different users can be connected to one another, with the result that navigation destination data can be dynamically input. As a result of a navigation destination being input by mobile communication apparatuses belonging to further users, distraction of the driver of the vehicle from the road traffic can be reduced further, with the result that navigation destinations can be transmitted to the navigation device of the vehicle during the journey without distracting the driver.

### LIST OF REFERENCE SYMBOLS

100 System
102 Navigation device of a vehicle
104 Mobile communication apparatus
106 Mobile communication apparatus
108 Wireless interface
110 Mobile communication apparatus
112 Geocoding module
114 Geocoding module
116 Geocoding service
118 Geocoding service
120 Geocoding service
122 Interface
124 Collision identification module
200 Method
202 Starting the method
204 Inputting navigation destination data
206 Setting up a connection
208 Transmitting navigation destination data
210 Generating a list of geocoding services
212 Selecting a geocoding service
214 Geocoding using the selected geocoding service
216 Geocoding using a predefined geocoding service
218 Setting up a connection to the navigation device of the vehicle
220 Transmitting geocoded navigation destination data
222 Identifying a collision
224 Adopting the geocoded navigation destination data as the navigation destination
226 Ending the method

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for transmitting a navigation destination to a navigation device of a vehicle, the method comprising the acts of:
receiving navigation destination data from a first mobile communication apparatus by way of a second mobile communication apparatus;
generating a list of geocoding services for geocoding the navigation destination data;
determining a geocoding service from the list of geocoding services;
geocoding the navigation destination data using the determined geocoding service;
transmitting the geocoded navigation destination data to the navigation device of the vehicle;
identifying a collision between the geocoded navigation destination data and possible navigation destination data from a navigation map of the navigation device of the vehicle; and
adopting the geocoded navigation destination data as the navigation destination of the navigation device of the vehicle if a collision has not been identified.

2. The method as claimed in claim 1, wherein
the navigation destination data from the first mobile communication apparatus comprise geocoded navigation destination data.

3. The method as claimed in claim 2, further comprising the acts of:
comparing the received geocoded navigation destination data from the first mobile communication apparatus with the geocoded navigation destination data from the determined geocoding service with regard to accuracy of the geocoded navigation destination data; and
selecting the more accurate geocoded navigation destination data as the geocoded navigation destination data which are transmitted to the navigation device (102) of the vehicle.

4. The method as claimed in claim 1, wherein
the second mobile communication apparatus is a smartphone; and/or
the first mobile communication apparatus is augmented reality glasses or a smartwatch.

5. The method as claimed in claim 1, further comprising the acts of:
receiving an input from a user via the first mobile communication apparatus, wherein the input from the user describes the navigation destination; and
setting up a communication connection between the first mobile communication apparatus and the second mobile communication apparatus.

6. The method as claimed in claim 3, further comprising the acts of:
receiving an input from a user via the first mobile communication apparatus, wherein the input from the user describes the navigation destination; and
setting up a communication connection between the first mobile communication apparatus and the second mobile communication apparatus.

7. The method as claimed in claim 1, wherein
the identification of a collision checks whether the geocoded navigation destination data is mappable to possible navigation destination data from the navigation map of the navigation device of the vehicle.

8. The method as claimed in claim 7, further comprising the act of:
if a collision has been identified:
(i) determining geocoded navigation destination data which are closest to the transmitted geocoded navigation destination data in the navigation map of the vehicle; and
(ii) adopting the determined geocoded navigation destination data as the navigation destination of the navigation device of the vehicle.

9. The method as claimed in claim 1, further comprising the act of:
if a collision has been identified:
(i) determining geocoded navigation destination data which are closest to the transmitted geocoded navigation destination data in the navigation map of the vehicle; and
(ii) adopting the determined geocoded navigation destination data as the navigation destination of the navigation device of the vehicle.

10. A system for transmitting a navigation destination to a navigation device of a vehicle, wherein the system is configured to:
receive navigation destination data from a first mobile communication apparatus by way of a second mobile communication apparatus;
generate a list of geocoding services for geocoding the navigation destination data;
determine a geocoding service from the list of geocoding services;
geocode the navigation destination data using the determined geocoding service;
transmit the geocoded navigation destination data to the navigation device of the vehicle;
identify a collision between the geocoded navigation destination data and possible navigation destination data from a navigation map of the navigation device of the vehicle; and
adopt the geocoded navigation destination data as the navigation destination of the navigation device of the vehicle if a collision has not been identified.

11. A vehicle, comprising:
a system for transmitting a navigation destination to a navigation device of the vehicle, wherein the system is configured to:
receive navigation destination data from a first mobile communication apparatus by way of a second mobile communication apparatus;
generate a list of geocoding services for geocoding the navigation destination data;
determine a geocoding service from the list of geocoding services;
geocode the navigation destination data using the determined geocoding service;
transmit the geocoded navigation destination data to the navigation device of the vehicle;
identify a collision between the geocoded navigation destination data and possible navigation destination data from a navigation map of the navigation device of the vehicle; and
adopt the geocoded navigation destination data as the navigation destination of the navigation device of the vehicle if a collision has not been identified.
